(19) United States
(12) Patent Application Publication
(10) Pub. No.: US 2024/0404364 A1
(43) Pub. Date: Dec. 5, 2024

(54) WEIGHTED PROGRESSIVE JACKPOT SYSTEM AND METHOD OF USING THE SAME ACROSS A LINKED GAMING NETWORK

(71) Applicant: Seven Aces LLC, Brighton, CO (US)

(72) Inventors: Todd Taylor, Brighton, CO (US); Adam Daines, Brighton, CO (US)

(21) Appl. No.: 18/679,092

(22) Filed: May 30, 2024

Related U.S. Application Data
(60) Provisional application No. 63/505,031, filed on May 30, 2023.

(51) Int. Cl. G07F 17/32

(52) U.S. Cl. CPC G07F 17/3258; G07F 17/3225; G07F 17/3293

(57) ABSTRACT

System and method utilizing weighted progressive jackpots across a plurality of games, including live table games and/or electronic gaming machines and/or online games of chance. The weighted progressive jackpots facilitate a more versatile system whereby players may win meaningful percentages of the progressive jackpots based on the game being played. The odds of winning all or a piece of the progressive jackpots and the amount being won are based on the game being played. Moreover, the linking of multiple game types into a single progressive pool grows the progressive jackpot pool faster benefiting all linked games.

### CROSS-REFERENCE

This application claims priority to U.S. Patent Application No. 63/505,031 filed on May 30, 2023 which is incorporated herein for all purposes.

### FIELD OF THE INVENTION

The embodiments of the present invention relate to systems and methods for funding and awarding progressive-style awards across multiple casino table games, electronic gaming devices, and/or online games of chance.

### BACKGROUND

Casinos derive their gaming revenue from electronic gaming machines (“EGMs”) such as slot machines and table games (e.g., Blackjack). Many of the EGMs (“Megabucks”) and table games (“Caribbean Stud Poker”) utilize progressive jackpots to entice players to play. Progressive jackpots are jackpots that grow over time until a player wins the progressive jackpot at which point the progressive jackpot resets to a default amount and starts growing again. Progressive jackpots may be funded by dedicated wagers or a percentage of regular game wagers.

In most instances, progressive jackpots involve a single game (e.g., Caribbean Stud Poker”) or EGM (e.g., Red White and Blue). There are some progressive jackpots that involve different games and may be won based on a player obtaining a pre-established outcome at one of the games thereby triggering the progressive jackpot. Such systems have drawbacks including very low odds of winning the progressive jackpot at any of the games.

Accordingly, the new system and method detailed herein involve utilizing a weighted progressive jackpot across a plurality of games, including live table games, EGMs and online games of chance. The use of weighted progressive jackpots facilitates a more versatile system whereby players may win meaningful percentages of the progressive jackpot based on the game being played. Thus, the odds of winning all or a piece of the progressive jackpot and the amount being won are based on the game being played. Moreover, the linking of multiple game types into a single progressive pool grows the progressive pool faster.

### SUMMARY

The embodiments of the present invention relate to systems and methods for generating progressive based on weighted outcomes. For example, in one embodiment, a plurality of Blackjack tables and Three-Card Poker tables may be networked together to fund a progressive jackpot. In said embodiment, a player playing Blackjack obtaining a hand of three same-suited 7s may be eligible to win all or a percentage of the common progressive jackpot while a player playing Three-Card Poker obtaining a three-card mini royal flush in spades may win all or a percentage of the common progressive jackpot. With six decks of cards, the chances of obtaining three same-suited 7s is 1 in 66,667 whereas the chances of obtaining a three-card mini royal flush in spades in Three-Card Poker is 1 in 22,100. Therefore, the Three-Card Poker player is approximately 3 times more likely to hit the progressive jackpot hand and win all or a percentage of the common progressive pool. In one embodiment, with the instant system, the Three-Card Poker player wins about 25% (22,100/(22,100+66,667)) of the progressive jackpot when obtaining a mini royal flush and the Blackjack player wins about 75% (66,667/(22,100+66,667)) of the progressive jackpot when obtaining the three same-suited 7s. Such a system permits the progressive jackpots to grow faster benefiting all players regardless of the percentage paid for the game being played.

The systems and methods detailed herein may also link online games to brick and mortar EGMs and table games to create even faster growing progressive jackpots.

Other weighting schemes are conceivable including weighting based on amounts wagered, availability of game types, etc.

Other variations, embodiments and features of the present invention will become evident from the following detailed description, drawings and claims.

### BRIEF DESCRIPTION OF THE DRAWINGS

FIG. 1 illustrates a block diagram of a multiple casino property system of the type that may be used to facilitate the embodiments of the present invention;

FIG. 2 illustrates a block diagram of a wireless network system of the type that may be used to facilitate the embodiments of the present invention;

FIG. 3 illustrates a block diagram of gaming tables networked to fund a progressive jackpot according to the embodiments of the present invention;

FIG. 4 illustrates a block diagram of gaming tables and EGMs networked to fund a progressive jackpot according to the embodiments of the present invention;

FIG. 5 illustrates a block diagram of gaming tables, EGMs and online games networked to fund a progressive jackpot according to the embodiments of the present invention;

FIG. 6 illustrates a flow chart detailing a methodology associated with paying progressive jackpots according to the embodiments of the present invention; and

FIGS. 7A and 7B show progressive information being displayed according to the embodiment of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

Those skilled in the art will recognize that the embodiments of the present invention involve both hardware and software elements, which portions are described below in such detail required to construct and operate a game method and system according to the embodiments of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.), or an embodiment combining software and hardware. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), and optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied thereon, for example, in baseband or as part of a carrier wave. Such a propagated signal may take any variety of forms, including, but not limited to, electromagnetic, optical, or any suitable combination thereof. A computer readable signal medium may be any computer readable medium that is not a computer readable storage medium and that can communicate, propagate, or transport a program for use by or in conjunction with an instruction execution system, apparatus, or device.

Program code embodied on a computer readable medium may be transmitted using any appropriate medium, including but not limited to wired, wireless, wireline, optical fiber cable, RF, Bluetooth and the like, or any suitable combination of the foregoing. Computer program code for carrying out operations for aspects of the present invention may be written in any combination of one or more programming languages, including an object-oriented programming language such as Java, Smalltalk, C++ or the like or conventional procedural programming languages, such as the “C” programming language, AJAX, PHP, HTML, XHTML, Ruby, CSS or similar programming languages. The programming code may be configured in an application, an operating system, as part of a system firmware, or any suitable combination thereof. The programming code may execute entirely on the user's computer, partly on the user's computer, as a standalone software package, partly on the user's computer and partly on a remote computer or entirely on a remote computer or server as in a client/server relationship sometimes known as cloud computing. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagrams. As used herein, a “gaming machine” should be understood to be any one of a general purpose computer, as for example a personal computer, laptop computer, standalone machine, a client computer configured for interaction with a server, a special purpose computer such as a server, or a smart phone, soft phone, tablet computer, personal digital assistant or any other machine adapted for executing programmable instructions in accordance with the description thereof set forth above.

Those skilled in the art will recognize that certain types of EGMs, generally utilized in regulated casino environments, are still commonly referred to as “slot machines”. Although the etymology of the term “slot machine” was originally derived from a coin slot in the gaming machines at the time, coin slots have long since generally been replaced by payment input devices or bill validators which only accept paper currency or ticket-in-ticket-out vouchers and/or electronic fund transfer means, such as card readers, mobile device payment means or account interfaces. As a result, the term EGM and slot machine are used interchangeably and are defined to mean something different than a laptop or desktop computer, cell phones, tablet computer gaming devices and the like.

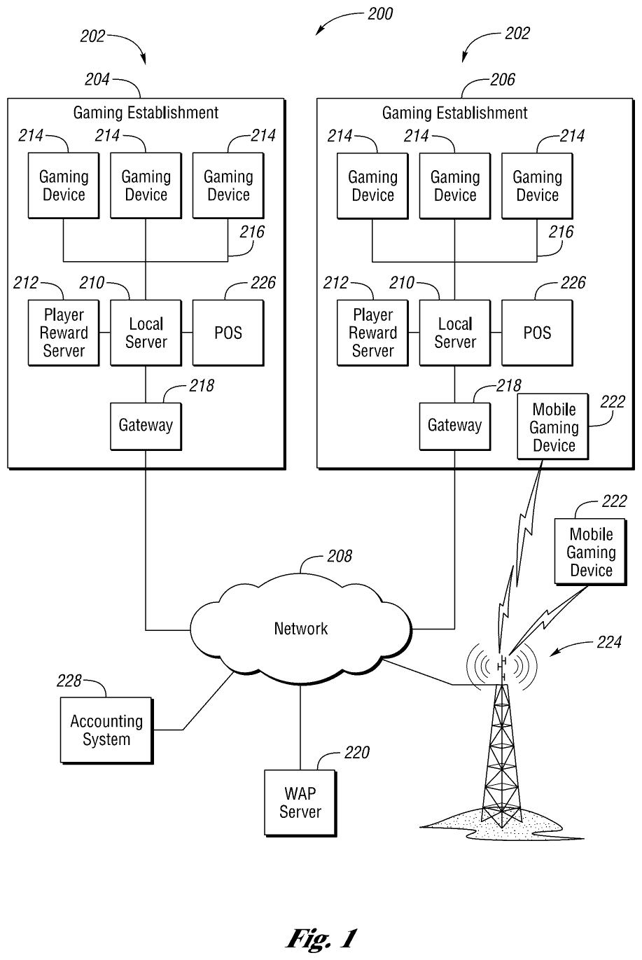

FIG. 1 illustrates a block diagram of a multiple property system that may be used to facilitate the embodiments of the present invention. This figure provides a view of exemplary gaming systems in multiple casinos. In one embodiment, a plurality of gaming devices 214 are connected to one or more servers 210 over a network 208, such as a wide area network (WAN) and/or a local area network (LAN). In one embodiment, the gaming devices 214 are electronic gaming machines (EGMs), otherwise known as “slot machines.” These may be classified as Class II, Class III, video lottery terminals (VLT), or the like. EGMs may present either one or a plurality of games to the player such as video reels, video poker, video keno, video bingo, electronic table games, and the like. In another embodiment, the gaming devices are gaming kiosks or terminals. The gaming devices also include table games managed by a live dealer or a virtual dealer. Alternatively, the gaming devices may include remote gaming devices, for example, cellular phones, laptop or desktop computers, and/or any other suitable devices. The servers may include one or more local servers within a gaming establishment and/or one or more wide area progressive (WAP) servers connected to the local servers and/or to the gaming devices through the network.

Each gaming device may include a randomization device, such as a random number generator (RNG) and/or a permutation generator or a deck of cards or dice, that is used to play a selected game on the gaming device. The randomization device may be used to randomly determine a game outcome for the game of chance. In another embodiment, at least some aspects of the game are provided by one or more servers, such as a local server 210, a wide area server, a local area progressive server (LAP), or a wide area progressive server (WAP) 220.

In the example of mechanical, electromechanical, or video reel machines, the games may include a number of mechanical or simulated rotating reels that are arranged in a horizontal configuration forming columns or vertical configurations forming rows. Alternatively, simulated rotating reels may be arranged in a vertical configuration forming columns or vertical configurations forming rows. One or a number of rows are presented to the player to allow for one or many different winning pay lines. Pay lines may be straight across or designed in any convenient fashion. A typical game many include five reels or columns and three or four rows or the like or a vertical configuration of five rows and three or four columns and the like.

In the example of the bingo game, the house indicia are compared to a plurality of player indicia that are included within a pattern selected for one or more player cards. If at least some of the player indicia within the pattern are matched by the house indicia, the player may win a prize based on the number of house indicia that have been matched and an associated pay table.

In the example of a keno game or a keno-related game of chance, the gaming device uses the randomization device to randomly select a plurality of house indicia in a similar manner as described with respect to the game of bingo. However, twenty house indicia are typically randomly selected or called from a pool of 80 house indicia, although other sizes of house indicia pools may be used. The called house indicia are compared to a plurality of player indicia to determine how many player indicia are matched by the house indicia and may be irrespective of a pattern of the player indicia. The embodiments described herein may include allowing the player to select the number of and specific player indicia to be utilized for a keno game or may include an automated or quick pick selection. For example, a player may select one player indicia or spot to play a 1 spot game, 2 player indicia or spots for a 2-spot game, 3 player indicia or spots for a 3-spot game, etc. Embodiments may also require a minimum number of player indicia or spots to match to win a game. For example, 10-player indicia or 10 spot game may require a minimum of 5-player indicia or spots to match the randomly selected player indicia. Embodiments may also include a maximum number of player indicia or spots that are playable. For example, in an 80-number game, the maximum number of house indicia or spots selectable by the player may be confined to 20 numbers or less or more. Accordingly, in an 80-number game, the minimum number of player indicia or spots may be 2 and the maximum player indicia or spots may be 20. The player may win one or more prizes based on the number of player indicia matched by the called house indicia.

In the example of a live Blackjack game, the gaming device/dealer uses one or more decks of physical cards to randomly determine game outcomes.

A technical effect of the systems and methods described herein includes one or more of: (a) presenting games of chance to a player on a gaming device including live table games and EGMs forming a network; (b) enabling the player to input or wager money or credits or physical items representing money or credits for use in the game of chance using a payment input device of the gaming device or conducting transactions with a live dealer; (c) enabling the player to withdraw money or credits from the gaming device using a payment output device of the gaming device or cashing out with a live dealer; (d) establishing a weighted progressive jackpot across all or select gaming devices forming the network; (e) randomly determining a game outcome for the game of chance using a randomization device; (f) determining, by the computing device, whether the player is eligible for a progressive jackpot award; and (g) determining, by the computing device, the amount/percentage of the progressive jackpot to be awarded.

As used herein, a “game of chance” or “game” refers to a manual or an electronic game that is played by a player in which an outcome of the game of chance is at least partially based on chance or a random selection of game components or skill-based game components. A game may be categorized by a game variety and/or a game size, for example. It should be recognized by those of ordinary skill in the art that the term “random” is not limited to true randomness, such as truly random numbers. Rather, pseudorandom numbers and pseudorandom algorithms are included within the meaning of “random.” In addition, those of ordinary skill in the art will recognize that permutation generators may additionally or alternatively be used to generate player card indicia or other game components.

Gaming devices described herein may use real money for play or may utilize a credit-based system in which the credits used for the games may or may not have a cash value. Similarly, prizes for the games may be in the form of credits, cash, and/or physical prizes such as televisions, automobiles, or the like.

System 200 is operated using components and devices within one or more gaming establishments 202, such as a first gaming establishment 204, a second gaming establishment 206, and a third gaming establishment 209. It should be recognized that any suitable number of gaming establishments 202 may be provided within system 200. Accordingly, system 200 is not limited to including two gaming establishments 202 as illustrated. In one embodiment, gaming establishments 202 are locations in which devices (e.g., gaming devices) that play or operate at least a portion of the game of chance are located. For example, gaming establishments 202 may be casinos, racetracks, bingo halls, keno parlors, or any other establishments. In another example, gaming establishments 202 may be residences or businesses in which one or more devices are located for playing or operating the game of chance. Gaming establishments 202 may additionally or alternatively include any combination of the examples described herein.

In one embodiment, gaming establishments 202 are physically remote from each other and are communicatively connected to at least one network 208, such as a wide area network (WAN), a metropolitan area network (MAN), and/or the Internet, for example. Alternatively, the gaming establishments 202 may be separate rooms or sections of a casino or another facility that are communicatively connected by network 208. It should be recognized that network 208 may be a wired Ethernet network, a wireless Ethernet network, a combination of wired and wireless Ethernet networks, or any other suitable wired and/or wireless network.

In one embodiment, each gaming establishment 202 includes a local game server 210 (referred to herein as a “local server”) and a player reward server 212. Local server 210 and player reward server 212 may alternatively be implemented as or within a single server. The local server 210 is coupled to a plurality of the gaming devices 214 through an internal network 216, such as a private local area network (LAN) within the gaming establishment 102, for example. The gaming devices 214 may be located in separate gaming establishments 202, or within the same gaming establishment 202. In one embodiment, a gateway 218 is provided to enable the local server 210 of each gaming establishment 202 to securely connect to the network 208.

In one embodiment, the local server 210 is a server computer (or “server”) that monitors and controls the games played on gaming devices 214, including local games. In one embodiment, the local games include games that are played against the house and/or that are played against other players within gaming establishment 202.

In addition, the local server 210 may administer other background tasks that enable games to be played on the gaming devices 214. For example, the local server 210 may facilitate authenticating gaming devices 214 and the players using the gaming devices 214 and may facilitate allocating payments or credits between players and the house. The local server 210 may include payment processing capabilities to enable players to receive electronic funds from a bank or another financial institution or to deposit electronic funds to the bank or financial institution. Alternatively, the payment processing capabilities may be included in a separate server or another device that is communicatively connected to the local server 210. In addition, the local server 210 may interface with the player reward server 212 to facilitate tracking and administering player rewards. Each gaming device 214, group of gaming devices 214, local servers 210, player reward servers 212, or the like may collect and/or generate data desired for accounting purposes, such as for use in slot accounting systems.

In one embodiment, the local server 210 may enable the gaming devices 214 within the gaming establishment 202 to participate in one or more games that share one or more progressive or pari-mutuel prizes with other gaming establishments 202 and/or gaming devices 214. While progressive prizes are described in embodiments herein, it should be recognized that pari-mutual prizes may be substituted as desired, and vice versa. In such an embodiment, each local server 210 may be coupled to a wide area progressive (WAP) server 220 that administers the prizes. For example, the WAP server 220 receives data from each local server 210 and/or from gaming devices 214 regarding an amount wagered by each player playing the game. WAP server 220 may allocate a portion of each wager to the prizes and may communicate the current prize amounts to local servers 210 and/or to the gaming devices 214.

Mobile gaming devices 222 may connect to local server 210, WAP server 220, and network 208 via a wireless data network represented by cell tower 224. For example, mobile gaming devices 222 may connect to any suitable network 108 (and thereby to local servers 210 and/or WAP server 120) via a “3G”, “4G” or a “5G” wireless data network. It should be recognized that mobile gaming devices 222 may additionally or alternatively connect to network 208 using another suitable wireless network, such as a wireless Ethernet network. For convenience, gaming devices 214 described herein may also include mobile gaming devices 222.

One or more point-of-sale (“POS”) terminals 226 or redemption kiosks may also be included within each gaming establishment 202 to enable players to “cash out” winnings from one or more gaming devices 214 and/or to perform other account management activities related to player accounts. The POS terminals 226 may be connected to the local server 210, for example, and/or to the WAP server 220 as desired.

In addition, the system 200 may include an auditing system 228 coupled to WAP server 220, the local server 210, and/or a gaming device 214, for example, through network 208. Accounting (auditing) system 228 may be used to audit and/or track components of system 200 to ensure compliance with applicable regulations.

In one embodiment, a plurality of gaming devices 214 having different operating systems and/or system architectures may connect to the local server 210 or to another suitable server to play one or more games of chance. In such an embodiment, the gaming devices 214 may be used to play a session bingo game, for example, or any other game of chance.

During operation, the player utilizes or selects a gaming device 214 and initiates a gaming session for playing one or more games of chance (“Games”). Optionally, the player inserts a player reward card or enters a player reward number or other identification information into gaming device 214. If the identification information is entered, the gaming device 214 may transmit the identification information to local server 210 for authentication, or authentication may be accomplished locally within the gaming device 214. The local server 210 communicates with player reward server 212 to establish the player's identity and to associate the gameplay with the player account. The local server 210 authenticates the player and gaming device 214 and authorizes the player to play the game or games on gaming device 214 if desired or required.

When game play is initiated, during selection of the game, or during play of the game, the player may be required to purchase or generate credits. The player may purchase or generate credits by inserting cash or a ticket-in-ticket-out voucher into gaming device 214 or another device. Cash, ticket-in-ticket-out vouchers, credit cards or debit cards are examples of physical items associated with the gaming device. Alternatively, or additionally, the player may transfer credits or cash to the gaming device 214 from banking accounts, credit accounts, gaming establishment accounts, and/or gaming company accounts. In one embodiment, computer-generated credits may be used with gaming device 214, for example, as part of a free-to-play game.

The player selects a game to play and enters a wager on the gaming device 214. The gaming device 214 transmits data representative of the selected game and the wager to the local server 210. If the player selects a game that is at least partially operated by the WAP server 220 or that includes one or more progressive prizes administered by WAP server 220, local server 210 transmits the wager and game information and/or selection to WAP server 220. The WAP server 220 may increment the progressive prizes based on the wager received from the player and may communicate the updated prize amounts via the network 208 to all other players (via associated gaming devices 214) playing to win the progressive prizes.

The player plays the game on the gaming device 214. The following gameplay is described as being administered by the WAP server 120. However, it should be recognized that the gameplay (i.e., the play of the game of chance) may be alternatively or additionally administered by the local server 210 and/or the gaming device 214. For example, if the gaming device 214 is a cellular phone or a tablet computing device, the gameplay may be administered through an application installed on the gaming device 214.

In one embodiment, the player may play a game of bingo by selecting a game or game type, one or more player cards, selecting one or more winning patterns for the player cards, and/or selecting one or more numbers or other player indicia for the player cards using the gaming device 214. The selected player cards, winning patterns, and player indicia are transmitted to WAP server 220. The player cards are included within one or more game tickets issued by WAP server 220, and the game tickets are communicated to the gaming device 214 via the network 208 and the local server 210. The WAP server 220 selects or receives randomly generated house indicia and compares the house indicia to the player indicia and the pattern or patterns selected for the player cards. Alternatively, the functions described herein (e.g., comparing the house indicia to the player indicia and the pattern or patterns selected for the player card) may be performed in the gaming device 214. It should be recognized that the house indicia may be randomly generated using a randomization device, such as hardware, firmware, and/or software-based random number generator (RNG), a ball blower or console, a ball cage, and/or any other suitable device or machine that enables numbers or other house indicia to be randomly generated. In an alternative embodiment, the WAP server 220 (or another device) may designate a server, computer, or another device to provide randomly selected house indicia during the game and may receive the house indicia from the designated device.

WAP server 220 determines whether the player wins a prize based on the comparison of the house indicia to the player indicia. For example, WAP server 220 determines whether the player indicia within the pattern or patterns selected for each card match the house indicia that were randomly determined (sometimes also referred to as the house indicia that were “called”). If the player indicia within a pattern match the called house indicia, the player may win a prize based on a pay table associated with the game. The prize may be one of the progressive prizes or the prize may be a fixed prize identified in the pay table. WAP server 220 determines the appropriate payout to be paid to the player based on the pay table and transmits data representative of the payout to local server 210.

Local server 210 receives the payout data and credits the player account accordingly. In addition, local server 110 may transmit the gameplay data and/or payout data to player reward server 112 to enable player reward server 112 to update the player history and other gameplay data for the player. When the player is done playing, the player may “cash out” some or all of the credits in the player account or may deposit the credits into the player account using POS terminal or kiosk 126, for example. The player account may be stored on gaming device 214, local server 210, or player reward server 212, for example.

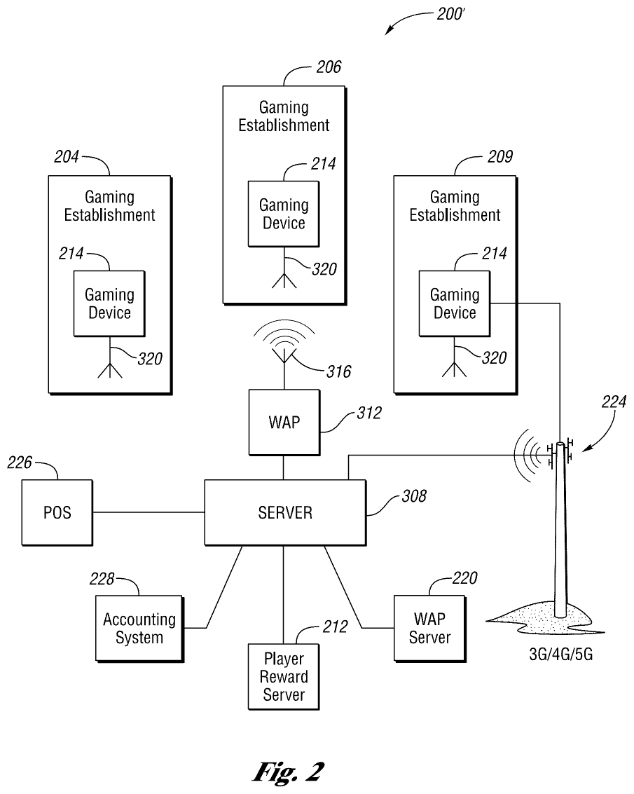

FIG. 2 is a block diagram of another system 200′ that may be used to play one or more games of chance, such as a slot, bingo, keno, or any game of chance. Unless otherwise specified, the system 200′ is similar to system 200 (shown in FIG. 1) and similar components are labeled in FIG. 2 with the same reference numerals used in FIG. 1. It should be understood that more or less components may be included within the various embodiments described herein.

In the embodiment shown in FIG. 2, the system 200′ includes a plurality of gaming devices 214 that are positioned in a plurality of gaming establishments 202. Gaming devices 214 may connect to a server 308 through a wireless access point 312. The wireless access points 308 includes an antenna 316 configured to wirelessly transmit to and receive signals from antennas 320 associated with the gaming devices 214. Wireless communications systems and methods are understood by one of ordinary skill in the art and as such are not described in detail here. For example, the gaming devices 214 may be playing one or more stand alone or Internet-based games that connect to the WAP server 220 through a server 308. In some embodiments, one or more gaming devices 214 may connect to the WAP server 220 and/or to the player reward server 212 through a wireless data network as described above. Accordingly, the gaming devices 214 interact with WAP server 220 to play the game, and WAP server 220 performs the game administration and other tasks handled by local server 210 as described above in FIG. 1. In a similar manner, a POS terminal 226 may connect to a gaming device 214 and/or WAP server 220 via network 208. In other respects, system 200 performs in a similar manner as described above.

During operation, the player utilizes or selects a gaming device 214 and initiates a gaming session to play one or more games on the gaming device 214. The player inserts a player reward card or enters a player reward number or other identification information into the gaming device 214. The gaming device 214 transmits the identification information to player reward server 212 to establish the player's identity and to associate the gameplay with the player account. The player reward server 212 authenticates the player and the gaming device 214 and may authorize the player to play the game on the gaming device 214. In one embodiment, the gaming device 214 also transmits the identification information to the WAP server 220 to enable the WAP server 220 to associate the player with the game to be played. As previously described, player identification or authentication may be optional.

In another embodiment, the WAP server 220 authenticates the player using the player identification information in addition to, or instead of, the authentication performed by the player reward server 212. In some embodiments, the player reward server 212 is omitted and the functions of player reward server 212 are incorporated within WAP server 220.

The player selects a game to play and enters a wager using gaming device 214. If the player selects a game that is operated by the WAP server 220 or that includes one or more progressive prizes administered by the WAP server 220, the gaming device 214 transmits the wager and game selection to the WAP server 220. The WAP server 220 may increment the progressive prizes based on the wager received from the player and may communicate the updated prize amounts over the wireless channel via the server 308 to all other players (via associated gaming devices 214) playing to win the progressive prizes.

Although shown as a wireless network, it is contemplated that the same functionality may be implemented in a wired system, or a combination of both.

The player plays the game on gaming device 214. The following gameplay is described as being administered by the WAP server 220. However, it should be recognized that the gameplay may be alternatively or additionally administered by the gaming device 214. For example, if the gaming device 214 is a cellular phone or a tablet computing device, the gameplay may be administered through an application installed on gaming device 214.

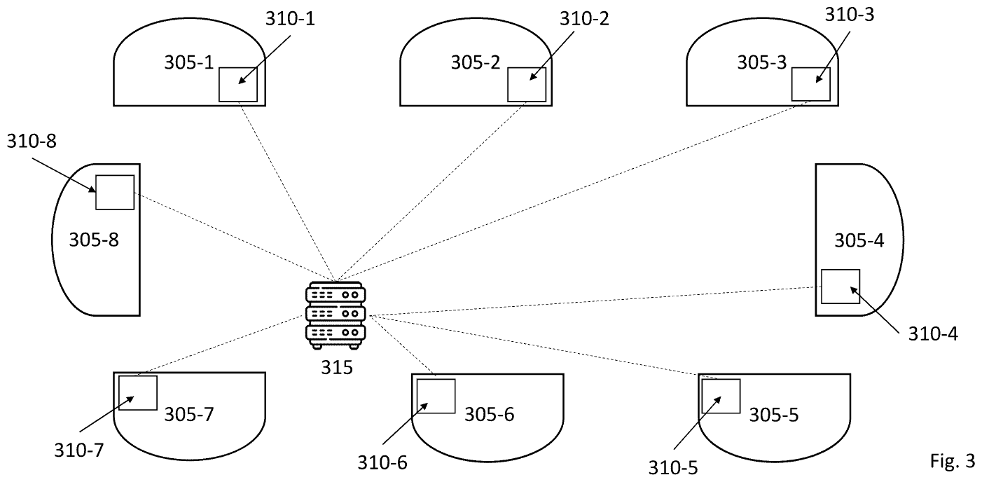

FIG. 3 is a block diagram 300 showing a casino layout of networked gaming devices, gaming tables 305-1 and 305-8 in this instance, that may facilitate the embodiments of the present invention. In one embodiment, gaming tables 305-1 to 305-4 support Blackjack games, gaming tables 305-5 and 305-6 support Three-Card Poker games and gaming tables 305-7 and 305-8 support Caribbean Stud Poker games. For purposes of the instant invention, each of the gaming tables 305-1 through 305-8 includes a computer 310-1 through 310-8 configured to manage the associated game. In one embodiment, each of the computers 310-1 through 310-8 includes at least a display, memory, processor and user interface. The computers 310-1 through 310-8 at each gaming table 305-1 through 305-8 communicate with a central computer/server 315 running executable instructions and gaming software including progressive game software according to the embodiments of the present invention. While not shown, each table 305-1 through 305-8 includes a progressive jackpot sign showing the current progressive jackpot(s).

According to the embodiments of the present invention, the networked gaming tables 305-1 through 305-8 support a weighted progressive jackpot. In one embodiment, progressive wagers placed at each gaming table 305-1 through 305-8 fund the progressive jackpot in an equal amount. For example, each of the gaming tables 305-1 through 305-8 may require a $1 or $5 progressive wager to participate in any progressive jackpot payout. In one embodiment, progressive jackpot payouts are weighted by the game played and the odds of a player obtaining the progressive jackpot outcome associated with the particular game. Table 1 below shows the game and exemplary progressive winning outcomes and odds associated therewith.

TABLE 1

| | WINNING PROGRESSIVE | |
|---|---|---|
| GAME | OUTCOME | ODDS |
| Blackjack | Three same-suited 7s | 1 in 66,667 |
| Three-Card Poker | Mini Royal Flush (spades) | 1 in 22,100 |
| Caribbean Stud Poker | Royal Flush | 1 in 649,351 |

As shown in Table 1, players at the Three-Card Poker tables have the best chance to win the progressive jackpot with players at the Blackjack table having the next best odds and finally players at the Caribbean Stud Poker have the lowest odds. To account for the different odds, the payouts are adjusted/weighted based on the game and the associated progressive outcome. In general, players hitting the Three-Card Poker progressive outcome are paid the smallest percentage of the progressive jackpot amount while players hitting the Blackjack progressive outcome are paid a larger percentage of the progressive jackpot amount and players hitting the Caribbean Stud Poker progressive are paid the largest percentage of the progressive jackpot amount. In one embodiment, using the exemplary odds from Table 1, players hitting the Three-Card Poker progressive outcome are paid about 3.0% (22,100/(22,100+66,667+649,351)) of the progressive jackpot amount while players hitting the Blackjack progressive outcome are paid about 9% (66,667/(22,100+66,667+649,351)) of the progressive jackpot amount and players hitting the Caribbean Stud Poker progressive are paid about 88% (649,351/(22,100+66,667+649,351)) of the progressive jackpot amount. By linking each of the gaming tables, overall larger progressive jackpot pools and associated jackpot payouts may be generated. The payouts detailed above may be reduced based on the house taking a percentage of each progressive wager placed. For example, with a $1 progressive wager, the casino may hold 10% (i.e., 10¢) and apportion the other 90% (i.e., 90¢) to the progressive jackpot pool. While separate progressive wagers are mentioned, it will be apparent to those skilled in the art that a portion of each player's primary game wager may be used to fund a progressive jackpot rather than a separate progressive wager.

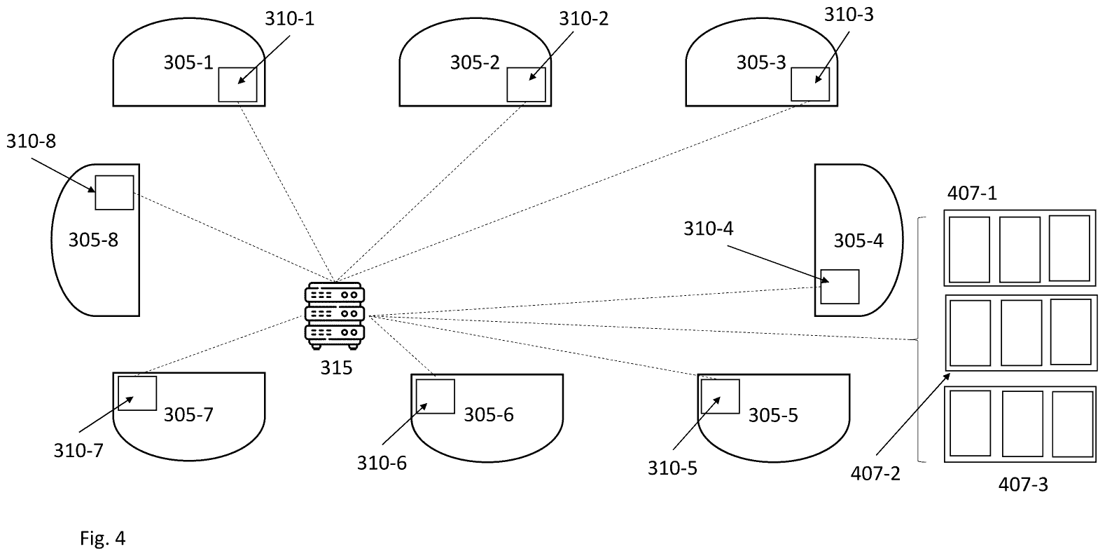

FIG. 4 is a block diagram 400 showing a casino layout of networked gaming devices, gaming tables 305-1 and 305-8 and three banks 407-1 through 407-3 of EGMs, each bank of EGMs comprising three EGMs that may facilitate the embodiments of the present invention. Like FIG. 3, gaming tables 305-1 to 305-4 support Blackjack games, gaming tables 305-5 and 305-6 support Three-Card Poker games and gaming tables 305-7 and 305-8 support Caribbean Stud Poker games and each of the gaming tables 305-1 through 305-8 includes a computer 310-1 through 310-8 configured to manage the associated game. The computers 310-1 through 310-8 at each gaming table 305-1 through 305-8 and the EGMs in the three banks 407-1 through 407-3 of EGMs communicate with a central computer/server 315 running executable instructions and gaming software including progressive game software according to the embodiments of the present invention.

Similarly to FIG. 3, the networked gaming tables 305-1 and 305-8 and banks 407-1 through 407-3 of EGMs support a weighted progressive jackpot. Table 2 below shows the game, progressive winning outcome and odds associated therewith.

TABLE 2

| | WINNING PROGRESSIVE | |
|---|---|---|
| GAME | OUTCOME | ODDS |
| Blackjack | Three same-suited 7s | 1 in 66,667 |
| Three-Card Poker | Mini Royal Flush (spades) | 1 in 22,100 |
| Caribbean Stud Poker | Royal Flush | 1 in 649,351 |
| EGMs | 3 Aligned Bonus Symbols | 1 in 250,000 |

As shown in Table 2, players at the Three-Card Poker tables have the best chance to win the progressive with players at the Blackjack table having the next best odds and players of the EGMs having the next best odds and finally players at the Caribbean Stud Poker having the longest odds. To account for the different odds, the payouts are adjusted/weighted based on the game. In general, players hitting the Three-Card Poker progressive outcome are paid the smallest percentage of the progressive jackpot amount while players hitting the Blackjack progressive outcome are paid a larger percentage of the progressive jackpot amount and players hitting the EGM progressive are paid an even larger percentage of the progressive jackpot amount and players hitting the Caribbean Stud Poker progressive are paid the largest percentage of the progressive jackpot amount. In one embodiment, using the exemplary odds from Table 2, players hitting the Three-Card Poker progressive outcome are paid about 2.2% (22,100/(22,100+66,667+250,000+649,351)) of the progressive jackpot amount while players hitting the Blackjack progressive outcome are paid about 6.7% (66,667/(22,100+66,667+250,000+649,351)) of the progressive jackpot amount and players hitting the EGM progressive outcome are paid about 25% (250,000/(22,100+66,667+250,000+649,351)) of the progressive jackpot amount and players hitting the Caribbean Stud Poker progressive are paid about 66% (649,351/(22,100+66,667+250,000+649,351)) of the progressive jackpot amount. Linking the gaming tables and EGMs generates overall larger progressive jackpots for players to participate in. The payouts detailed above may be reduced based on the house taking a percentage of each progressive wager placed. For example, with a $5 progressive wager, the casino may hold 10% (i.e., 50¢) and apportion the other 90% (i.e., $4.50) to the progressive jackpot pool.

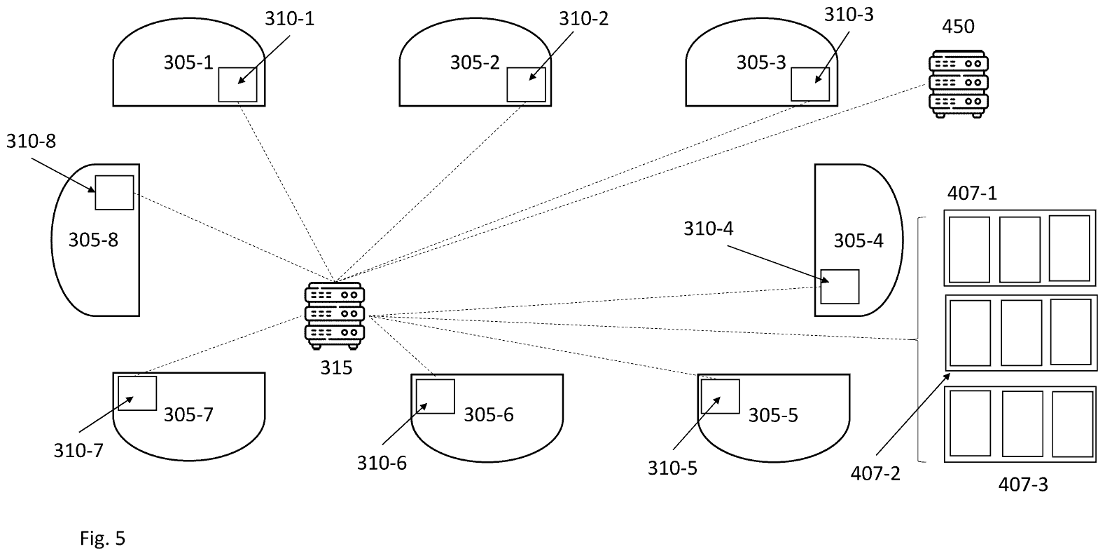

FIG. 5 is a block diagram 500 showing a casino layout of networked gaming devices, gaming tables 305-1 and 305-8 and three banks 407-1 through 407-3 of EGMs, each bank of EGMs comprising three EGMs, that may facilitate the embodiments of the present invention. Like FIGS. 3 and 4, gaming tables 305-1 to 305-4 support Blackjack games, gaming tables 305-5 and 305-6 support Three-Card Poker games and gaming tables 305-7 and 305-8 support Caribbean Stud Poker games and each of the gaming tables 305-1 through 305-8 includes a computer 310-1 through 310-8 configured to manage the associated game. The computers 310-1 through 310-8 at each gaming table 305-1 through 305-8 and the EGMs forming the three banks 407-1 through 407-3 of EGMs communicate with a central computer/server 315 running executable instructions and gaming software including progressive game software according to the embodiments of the present invention.

In this embodiment, the central computer/server 315 also communicates with an online server 450 running executable instructions to facilitate online game of chance. Such games are played using smart phones, smart tablets, laptop computers and desktop computers in communication with the remote server 450. Many of the online games of chance are the same (e.g., Blackjack, Three-Card Poker, etc.) as those played in the brick and mortar casinos. Other online games of chance may be unique to the online platform. In one embodiment, the online games of chance matching the brick and mortar games of chance, form part of the progressive network. For example, online tables games and slot games found in brick and mortar casinos and having the same odds are linked to the progressive network. Other online games not found in brick and mortar casinos may be linked to the progressive jackpot if certain game outcomes support a progressive-type award.

As shown in Table 3, players at the Three-Card Poker tables have the best chance to win the progressive with players at the Blackjack table having the next best odds and players of the EGMs having the next best odds and players of the online Bingo game of chance having the next best odds and finally players at the Caribbean Stud Poker having the longest odds. To account for the different odds, the payouts are adjusted/weighted based on the game. In general, players hitting the Three-Card Poker progressive outcome are paid the smallest percentage of the progressive jackpot amount while players hitting the Blackjack progressive outcome are paid a larger percentage of the progressive jackpot amount and players hitting the EGM progressive are paid an even larger percentage of the progressive jackpot amount and players hitting the Caribbean Stud Poker progressive are paid the largest percentage of the progressive jackpot amount. In one embodiment, using the exemplary odds from Table 3, players hitting the Three-Card Poker progressive outcome are paid about 1.6% (22,100/(22,100+66,667+250,000+649,351+434,782)) of the progressive jackpot amount while players hitting the Blackjack progressive outcome are paid about 4.7% (66,667/(22,100+66,667+250,000+649,351+434,782)) of the progressive jackpot amount and players hitting the EGM progressive outcome are paid about 17.6% (250,000/(22,100+66,667+250,000+649,351+434,782)) of the progressive jackpot amount and players hitting the online Bingo coverall are paid about 30.6% (434,782/(22,100+66,667+250,000+649,351+434,782)) of the progressive jackpot and players hitting the Caribbean Stud Poker progressive are paid about 45.6% (649,351/(22,100+66,667+250,000+649,351+434,782)) of the progressive jackpot amount. Linking the gaming tables, EGMs and online games generates overall larger progressive jackpots for players to participate in. The payouts detailed above may be reduced based on the house taking a percentage of each progressive wager placed.

TABLE 3

| | WINNING PROGRESSIVE | |
|---|---|---|
| GAME | OUTCOME | ODDS |
| Blackjack | Three same-suited 7s | 1 in 66,667 |
| Three-Card Poker | Mini Royal Flush (spades) | 1 in 22,100 |
| Caribbean Stud Poker | Royal Flush | 1 in 649,351 |
| EGMs | 3 Aligned Bonus Symbols | 1 in 250,000 |
| Online-Bingo | 50 ball draw coverall | 1 in 434,782 |

While not shown, any live games of chance may be linked to the progressive network. For example, live bingo and keno games may be linked to the progressive network. Also, certain jurisdictions permit bars, convenience stores and other locations to operate a restricted number of EGMs which may also be linked to the progressive network. Electronic poker tables (e.g., PokerTek), live poker tables and online poker tables may also be linked to the progressive network. For example, poker tables playing Texas Hold'em may incorporate any royal flush or a royal flush in a certain suit as the progressive outcome. In one embodiment, live and online sports books are linked to the progressive network and may accept certain wagers having an associated progressive payout.

In one embodiment, there is a progressive pool generated for a range of progressive wager denominations accepted. For example, there may be five unique progressive pools using weighted payouts based on $1, $2, $3, $4 and $5 progressive wagers, respectively, placed by the player.

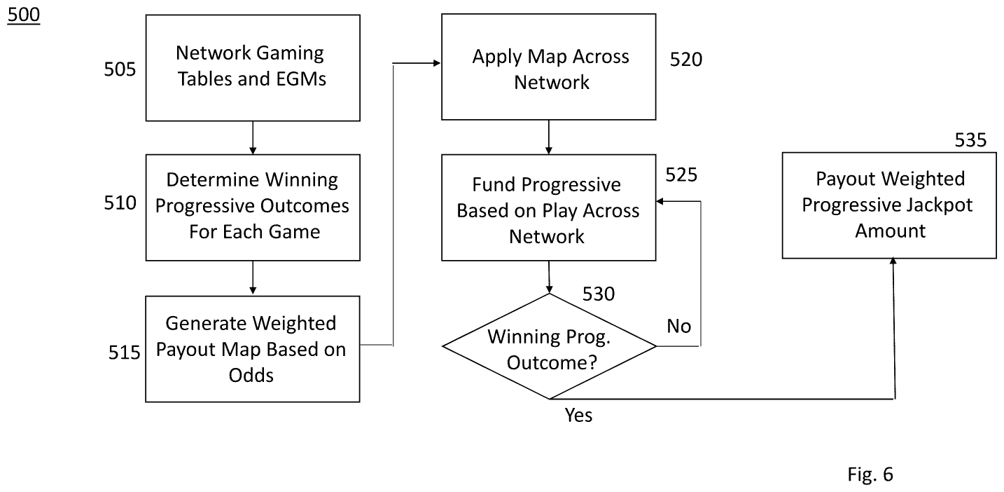

FIG. 6 shows a flow chart 500 detailing an exemplary methodology for utilizing the weighted progressive jackpot according to the embodiments of the present invention. At 505, gaming tables and EGMs are linked via computer network. At 510, winning progressive outcomes are determined for each linked game. For the same games (e.g., Blackjack), the same outcome is utilized. At 515, a payout map is generated based on the odds of each different progressive outcome. At 520, the map is applied across the network. At 525, the progressive jackpot is funded by play at all linked games. At 530, it is determined if any player hits a progressive outcome at any of the linked gaming tables or EGMs. If so, at 535, the progressive jackpot is paid for the outcome achieved. If not, the flow chart loops back to 525. The flow chart 500 may be modified at 505 to link online games of chance, poker tables, sports books, etc.

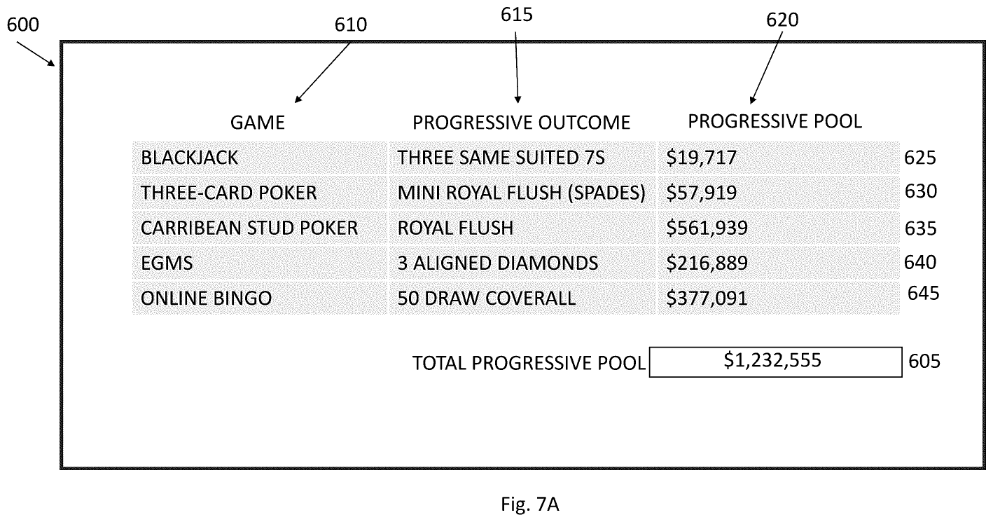

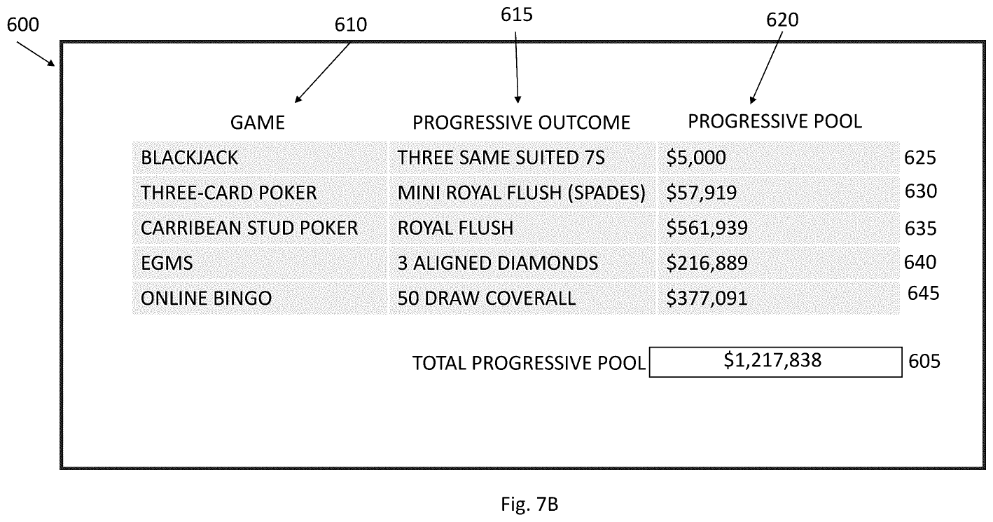

FIG. 7A shows an exemplary display 600 showing progressive jackpot details for players to view as they play the games of chance. As shown, the display 600 depicts a progressive pool amount 605 and three columns comprising a game column 610, progressive outcome trigger column 615 and progressive payout amounts 620. The display 600 shows a Blackjack payout amount 625, Three-Card Poker payout amount 630, a Caribbean Stud Poker payout amount 635, a slot payout amount 640 and an online Bingo payout amount 645. In practice, the payouts amounts increase in real time as progressive bets are placed until the point that a certain progressive jackpot is won in which instance, as shown in FIG. 7B, the total progressive payout amount and progressive payout amount for the specific game are changed to reflect the progressive payout. The payout for any specific game does not alter the progressive payouts for the other games. In FIG. 7B, after the Blackjack progressive is won, the Blackjack progressive payout amount 625 is paid and the Blackjack progressive payout amount 610 is reset to a base amount (e.g. $5,000) and the total progressive pool amount 605 is adjusted accordingly.

Those skilled in the art will recognize that the weighted payouts detailed above are exemplary only and may be adjusted or scaled for any number of reasons including wager amounts, wager denomination, game popularity, progressive funding schemes, etc. The objective of the embodiments of the present invention is to utilize a network of live games of chance, EGMs and/or online games of chance to fund and payout progressive jackpots weighted by the associated odds of obtaining the progressive jackpot outcome trigger and build larger progressive jackpot pools.

Although the invention has been described in detail with reference to several embodiments, additional variations and modifications exist within the scope and spirit of the invention as described and defined in the following claims.

We claim:

1. A gaming system comprising:
a central computer having one or more processors;
a network comprising:
one or more online games of chance and/or one or more live games of chance and/or one or more electronic gaming machines each in communication with said central computer;
wherein said central computer manages a weighted progressive jackpot funded by play across said network of said one or more online games of chance and/or said one or more live games of chance and/or said one or more electronic gaming machines; and
wherein progressive jackpot payout amounts associated with said progressive jackpot are based on weighted odds of obtaining a progressive outcome trigger at each game played across said network of said one or more online games of chance and/or said one or more live games of chance and/or said one or more electronic gaming machines.

2. The gaming system of claim 1 wherein said live games of chance include live poker tables, electronic poker tables and online poker tables.

3. The gaming system of claim 1 wherein said online games of chance are controlled by a server with one or more processors running executable instructions.

4. The gaming system of claim 1 further comprising a display depicting weighted jackpot payout amounts for said progressive outcome trigger at each game played across said network.

5. The gaming system of claim 1 wherein said progressive jackpot is funded using progressive wagers separate from primary game wagers.

6. A gaming system comprising:
a central computer having one or more processors;
a network comprising:
one or more online games of chance and/or one or more live games of chance and/or one or more electronic gaming machines each in communication with said central computer;
wherein said central computer manages two or more progressive jackpots funded by play across said network of said one or more online games of chance and/or said one or more live games of chance and/or said one or more electronic gaming machines, each of said two or more progressive jackpots funded by a unique wager denomination; and
wherein progressive jackpot payout amounts associated with said two or more progressive jackpots are based on weighted odds of obtaining a progressive outcome trigger at each game played across said network of said one or more online games of chance and/or said one or more live games of chance and/or said one or more electronic gaming machines.

7. The gaming system of claim 6 wherein said live games of chance include live poker tables, electronic poker tables and online poker tables.

8. The gaming system of claim 6 wherein said online games of chance are controlled by a server with one or more processors running executable instructions.

9. The gaming system of claim 6 further comprising a display depicting weighted jackpot payout amounts for said progressive outcome trigger at each game played across said network.

10. The gaming system of claim 6 wherein said two or more jackpots are funded with progressive wagers of different denominations.

11. The gaming system of claim 6 wherein said two or more progressive jackpots are funded using progressive wagers separate from primary game wagers.

12. A gaming method comprising:
forming a network including a central computer having one or more processors, one or more online games of chance and/or one or more live games of chance and/or one or more electronic gaming machines each in communication with said central computer;
configuring said central computer to manage a weighted progressive jackpot funded by play across said network of said one or more online games of chance and/or said one or more live games of chance and/or said one or more electronic gaming machines; and
establishing progressive jackpot payouts associated with said weighted progressive jackpot based on weighted odds of obtaining a progressive outcome trigger at each game played across said network of said one or more online games of chance and/or said one or more live games of chance and/or said one or more electronic gaming machines.

13. The gaming method of claim 12 wherein said live games of chance include live poker tables, electronic poker tables and online poker tables.

14. The gaming method of claim 12 wherein said online games of chance are controlled by a server with one or more processors running executable instructions.

15. The gaming method of claim 12 further comprising configuring a display to depict weighted jackpot payout amounts for said progressive outcome trigger at each game played across said network.

16. The gaming method of claim 12 wherein said progressive jackpot is funded using progressive wagers separate from primary game wagers.

17. A gaming method comprising:
forming a network including a central computer having one or more processors, one or more online games of chance and/or one or more live games of chance and/or one or more electronic gaming machines each in communication with said central computer;
configuring said central computer to manage one or more weighted progressive jackpots funded by play across said network of said one or more online games of chance and/or said one or more live games of chance and/or said one or more electronic gaming machines; and
establishing progressive jackpot payouts associated with said one or more weighted progressive jackpots based on weighted odds of obtaining a progressive outcome trigger at each game played across said network of said one or more online games of chance and/or said one or more live games of chance and/or said one or more electronic gaming machines.

18. The gaming method of claim 17 wherein said live games of chance include live poker tables, electronic poker tables and online poker tables.

19. The gaming method of claim 17 wherein said online games of chance are controlled by a server with one or more processors running executable instructions.

20. The gaming method of claim 17 further comprising configuring a display to depict weighted jackpot payout amounts for said progressive outcome trigger at each game played across said network.

21. The gaming method of claim 17 further comprising funding said two or more jackpots with progressive wagers of different denominations.

22. The gaming method of claim 17 further comprising funding said two or more progressive jackpots using progressive wagers separate from primary game wagers.
